(19) United States
(12) Patent Application Publication
(10) Pub. No.: US 2005/0141418 A1
(43) Pub. Date: Jun. 30, 2005

(54) Ring buffer management system and ring buffer management method

(75) Inventors: Choon-kyoung Moon, Yongin-si (KR); Yong-jun Lim, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 11/006,737

(22) Filed: Dec. 8, 2004

(30) Foreign Application Priority Data
Dec. 8, 2003 (KR) 2003-88775

(51) Int. Cl. G06F 11/00; H04J 3/14

(52) U.S. Cl. 370/229

(57) ABSTRACT

A ring buffer management system includes a layer interface, which transmits an occupied buffer size or a free buffer size of the ring buffer to a low layer module and/or a high layer module of a TCP/IP stack; a pointer update interface, which calculates a temporary pointer based on a current pointer of the ring buffer and a data size necessary for the high layer module or the low layer module; and a pointer manager, which stores the current pointer of the ring buffer, updates the ring buffer by using the temporary pointer, and calculates the occupied buffer size and the free buffer size of the ring buffer to transmit the calculated occupied buffer size and the free buffer size to the layer interface, so that it is possible to prevent data transmission delay and efficiently manage the ring buffer because the high/low layer module of the TCP/IP stack can appropriately determine a transmit/receive data size.

### CROSS-REFERENCE TO RELATED APPLICATIONS

This application claims the priority of Korean Patent Application No. 2003-88775, filed on Dec. 8, 2003 in the Korean Intellectual Property Office, the disclosure of which is incorporated herein in its entirety by reference.

### BACKGROUND OF THE INVENTION

1. Field of the Invention

The present invention relates to ring buffer management for transmission control protocol/internet protocol (TCP/IP) communication, and more particularly, to a ring buffer management system and a ring buffer management method implemented by using hardware in order to efficiently manage the ring buffer for TCP/IP communication.

2. Description of the Related Art

A TCP/IP protocol stack is a set of various kinds of protocols such as transmission control protocol (TCP), user datagram protocol (UDP), internet protocol (IP), address resolution protocol (ARP), reverse address resolution protocol (RARP), internet control message protocol (ICMP), internet group management protocol (IGMP), and so on. As shown in FIG. 1, data transmitted from an application protocol layer of a host corresponding to the upper layer of the TCP/IP stack are processed in a unit of a packet, and then transmitted to a physical layer such as a network interface card (NIC) corresponding to the lower layer of the TCP/IP stack. Conversely, when data are received from another host, the above process is performed in reverse.

In order to transmit information through networks, a buffer, that is, a temporary data storage is provided. Since a buffer size can not be physically infinite, a memory buffer (M-buffer) has been implemented by using a software technique so that the buffer size limitation can be removed. On the contrary, when the TCP/IP stack is processed by using hardware, it is very difficult to establish the buffer size in a variable manner. Therefore, in order to solve this problem, a ring buffer has been adopted. For adopting the ring buffer, it is important to manage a buffer pointer or determine a free buffer size or an occupied buffer size.

According to a conventional process of determining the free buffer size and notifying a TCP layer in order to write to-be-transmitted data to the ring buffer in a case of data transmission, a free buffer size (FBS) function is called before a quantity of necessary data packets are transmitted from the TCP layer. Then, the FBS function calculates a current free buffer size and compares the calculated size with a transmit data size so as to write the transmit data to the buffer and establishes a send bit as 1 in a predetermined area of a buffer manager when the free buffer size becomes larger than the transmit data size.

According to the above conventional art, in order that the TCP/IP stack writes or reads data to/from the ring buffer, it is necessary to previously process a request to calculate the free buffer size or the occupied buffer size of the ring buffer. Furthermore, when a transmit/receive data size is larger than the calculated free buffer size or the occupied buffer size, it is necessary to wait until the free buffer size or the occupied buffer size becomes larger than the transmit/receive data size. This causes transmission delays.

In addition, since the buffer pointers are updated immediately after the transmit/receive data are written or read to/from the ring buffer, it is difficult to restore the updated buffer pointers when cancellation of the transmit/receive data occurs.

### SUMMARY OF THE INVENTION

According to an aspect of the present invention, there is provided a ring buffer management system implemented by using hardware for TCP/IP communication, the system including: a layer interface which transmits an occupied buffer size or a free buffer size of the ring buffer to a low layer module and/or a high layer module of a TCP/IP stack; a pointer update interface which calculates a temporary pointer based on a current pointer of the ring buffer and a data size necessary for the high layer module or the low layer module; and a pointer manager which stores the current pointer of the ring buffer, updates the ring buffer by using the temporary pointer, and calculates the occupied buffer size and the free buffer size of the ring buffer to transmit the calculated occupied and free buffer sizes to the layer interface.

In an aspect of the present invention, the pointer manager updates the ring buffer by using the temporary pointer when an update request for the temporary pointer is received from the TCP/IP stack.

In an aspect of the present invention, the pointer update interface receives the current pointer from the pointer manager and the necessary data size from the TCP/IP stack to calculate the temporary pointer.

In an aspect of the present invention, the high layer module and the low layer module determine the necessary data size so as to be smaller than the occupied buffer size and the free buffer size transmitted from the layer interface.

In an aspect of the present invention, the pointer manager transmits the free buffer size and the occupied buffer size to the layer interface through a pointer control block which stores information on the free buffer size and the occupied buffer size.

In an aspect of the present invention, the pointer update interface determines the temporary pointer based on the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size. Equation 1

In an aspect of the present invention, the pointer update interface transmits a turn-around bit indicating whether or not a sum of the current write pointer of the ring buffer and the necessary data size exceeds a highest pointer of the ring buffer to the pointer manager, and the pointer manager may calculate the free buffer size based on the turn-around bit and the updated temporary pointer.

In an aspect of the present invention, the pointer manager determines the free buffer size based on the following equation:
if Pr>Pw, FBS=Pr−Pw;
if Pr<Pw, FBS=m−m−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer of the ring buffer;
Pw is a temporary write pointer;
TAB is the turn-around bit; and
FBS is the free buffer size. Equation 2

According to another aspect of the present invention, there is provided a ring buffer management system implemented by using hardware for TCP/IP communication, the system including: a TCP/IP hardware stack which implements the TCP/IP communication by using hardware and outputs a pointer update signal for the ring buffer; a layer interface which transmits an occupied buffer size and/or a free buffer size of the ring buffer to a low layer module and/or a high layer module of the TCP/IP hardware stack; a pointer update interface which calculates a temporary pointer based on a data size necessary for the high layer module or the low layer module and a current pointer of the ring buffer, and outputs a turn-around bit indicating whether or not a sum of the current pointer and the necessary data size exceeds a highest pointer of the ring buffer together with the temporary pointer; a pointer manager which transmits the current pointer of the ring buffer to the pointer update interface, receives the pointer update signal output from the TCP/IP hardware stack, updates the ring buffer by using the temporary pointer, and calculates and outputs the free buffer size and the occupied buffer size based on the turn-around bit output from the pointer update interface and the temporary pointer; and a pointer control block which stores the occupied buffer size and the free buffer size output from the pointer manager and transmits the stored occupied and free buffer sizes to the layer interface.

In an aspect of the present invention, the temporary pointer and the free buffer size are determined based on the above Equation 1 and Equation 2.

According to another aspect of the present invention, there is provided a ring buffer management method implemented by using hardware for TCP/IP communication, the method including receiving a necessary data size from a TCP/IP stack; calculating a temporary pointer based on the necessary data size and a current pointer of the ring buffer; updating the ring buffer by using the temporary pointer; calculating an occupied buffer size and a free buffer size of the ring buffer; and transmitting the calculated free buffer size and/or the occupied buffer size to a low layer module and/or a high layer module of the TCP/IP stack.

In an aspect of the present invention, the ring buffer is updated by using the temporary pointer when an update request for the temporary pointer is received from the TCP/IP stack.

In an aspect of the present invention, the ring buffer management method further includes determining the necessary data size to be smaller than the calculated occupied buffer size and the calculated free buffer size; and transmitting the determined necessary data size to the TCP/IP stack.

In an aspect of the present invention, the temporary pointer is determined by the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size.

In an aspect of the present invention, the ring buffer management method further includes generating a turn-around bit indicating whether or not a sum of the necessary data size and a current write pointer of the ring buffer exceeds a highest pointer of the ring buffer, and the free buffer size may be calculated based on the generated turn-around bit and the temporary pointer.

In an aspect of the present invention, the free buffer size is determined based on the following equation:
if Pr>Pw, FBS=Pr−Pw;
if Pr<Pw, FBS=m−m−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer of the ring buffer;
Pw is a temporary write pointer;
TAB is the turn-around bit; and
FBS is the free buffer size.

According to another aspect of the present invention, there is provided a ring buffer management method implemented by using hardware for TCP/IP communication, the method including receiving a necessary data size from a TCP/IP stack; calculating a temporary pointer based on the necessary data size and a current pointer of the ring buffer; generating a turn-around bit indicating whether or not a sum of a current write pointer of the buffer and the necessary data size exceeds a highest pointer of the ring buffer; updating the ring buffer by using the temporary pointer when a pointer update signal is received from the TCP/IP stack; calculating an occupied buffer size and a free buffer size of the ring buffer based on the temporary pointer and the turn-around bit; and transmitting the calculated free buffer size and/or the occupied buffer size to a high layer module and/or a low layer module of the TCP/IP stack.

In an aspect of the present invention, the current pointer and the free buffer size are determined based on the above Equation 1 and Equation 2.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram showing a conventional protocol layer structure implementing TCP/IP communication;

FIG. 2 is a block diagram showing a ring buffer management system according to an exemplary embodiment of the present invention;

FIG. 3 is a conceptual diagram illustrating calculation of the temporary pointer and generation of a turn-around bit;

FIG. 4 is a conceptual diagram illustrating calculation of the free buffer size; and

FIG. 5 is a flow chart showing a ring buffer management method according to an exemplary embodiment of the present invention.

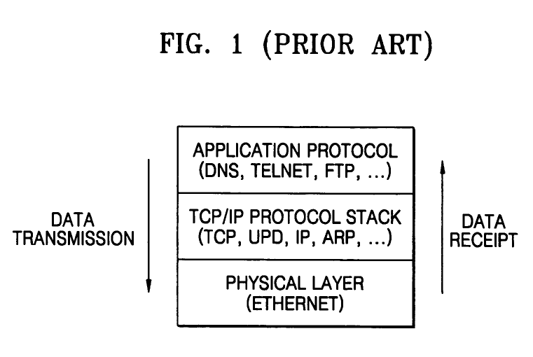

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

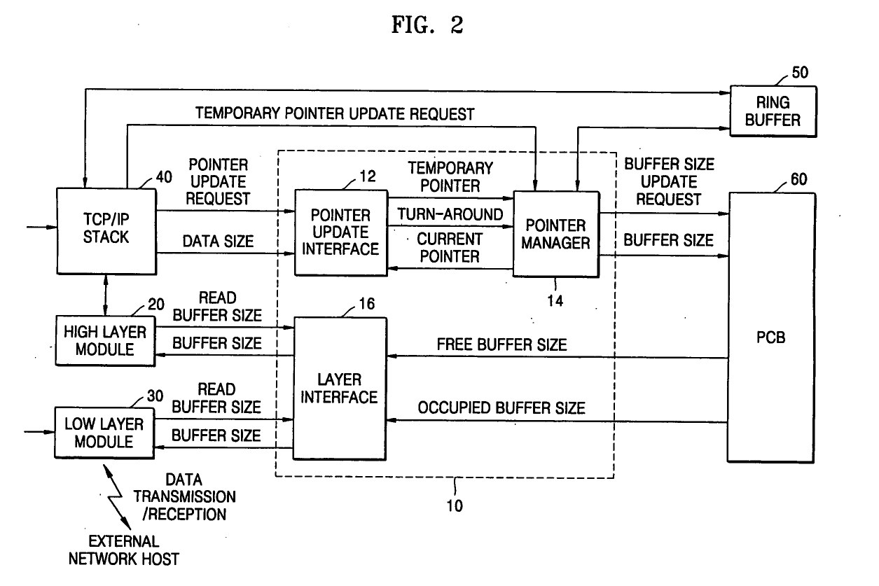

Referring to FIG. 2, the ring buffer management system 10 comprises a pointer update interface 12, a pointer manager 14, and a layer interface 16. The ring buffer management system 10 is implemented by using hardware according to aspects of the present invention. The hardware stack according to embodiments of the present invention can be embodied by chips such as a field programmable gate array (FPGA), an application specific integrated circuit (ASIC), or an application specific standard product (ASSP). The “hardware-implemented” ring buffer management system 10 refers to implementing all functions by electrical circuits included in the chips such as the FPGA. Meanwhile, the ring buffer 50 has a write pointer which designates a data write point and a read pointer which designates a data read point.

The pointer update interface 12 receives a pointer update request, a data size to be written or read to/from the ring buffer 50, and a current pointer of the ring buffer 50 from the TCP/IP stack 40 and the pointer manager 12. Then, the pointer update interface 12 generates and transmits a temporary pointer to the pointer manager 14.

The temporary pointer is determined by the sum of a current pointer of the ring buffer 50 and the data size transmitted from the TCP/IP stack 40. The temporary pointer has to receive a temporary pointer update request from the TCP/IP stack 40 before being updated to a new pointer. This is because it will be difficult to recover the buffer pointer if the buffer pointer is updated when cases occur in which processing of the transmit/receive data must be cancelled or interrupted due to any possible reasons during the processing of the TCP/IP packets in the TCP/IP stack 40.

During calculating the temporary pointer, the pointer update interface 12 determines whether or not a sum of the current write pointer and the data size exceeds the highest pointer of the ring buffer 50. Then, the pointer update interface 12 generates and transmits a turn-around bit (TAB) to the pointer manager 14.

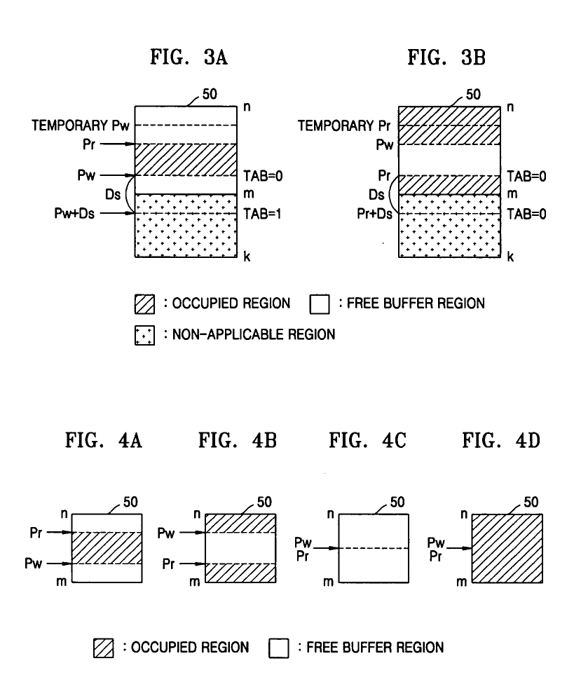

Referring to FIGS. 3A-3B, the ring buffer 50 has a storage space between the highest pointer m and the lowest pointer n. Pw is a write pointer where data starts to be written to the ring buffer 50 in case of data transmission. Pr is a read pointer where data starts to be read from the ring buffer 50 in case of data reading.

FIG. 3A shows the case when the temporary write pointer Pw exceeds a highest pointer m when the TCP/IP stack 40 requests the data size of Ds from the pointer update interface 12 in order to write data to the ring buffer 50. The temporary write pointer Pw is set to Pw+Ds if the transmit data size does not exceed the highest pointer m.

In other words, if the data size requested by the TCP/IP stack 40 exceeds the highest pointer m of the ring buffer 50 from a current write pointer, the temporary write pointer Pw is set to Pw+Ds+n−m, and the turn-around bit (TAB) is set to 1. In this case, the temporary pointer Pw cannot exceed a current read pointer Pr. This is attainable because the high layer module 20 or the low layer module 30 can identify the data size to be written or read to/from the ring buffer 50 on a real-time basis through the layer interface 16 according to aspects of the present invention.

Similarly to FIG. 3A, the temporary read pointer Pr can be calculated according to FIG. 3B. Therefore, a temporary pointer Pn can be attained based on the following conditional equation.
if (Pp+Ds)≦m, Pn=Pp+Ds; or
if (Pp+Ds)>m, Pn=Pp+Ds+n−m, Equation 1

where, Pp is the current pointer, and Pn is the temporary pointer.

The pointer manager 14 which has received the TAB and the temporary pointer calculated by the pointer update interface 12 updates the current pointer of the ring buffer 50 by using the temporary pointer if a temporary pointer update request is received from the TCP/IP stack 40. In addition, the pointer manager 14 calculates the free buffer size of the ring buffer 50 and the current occupied buffer size, and then outputs a buffer size update request and the free and occupied buffer sizes to a pointer control block (PCB) 60. The PCB 60 updates the free and occupied buffer sizes of the ring buffer 50 depending on the request from the pointer manager 14, and then transmits the updated free and occupied buffer sizes to the layer interface 16.

The layer interface 16 outputs the updated free buffer size or the occupied buffer size to a high layer module 20 and a low layer module 30. The high layer module 20 and the low layer module 30 each determines a data size appropriate to be written or read to/from the ring buffer 50 based on the updated free and occupied buffer size transmitted from the layer interface 16 so as to transmit the data to the TCP/IP stack 40. Therefore, the layer interface 16 can be separately implemented for the high layer interface and the low layer interface so as to control the high layer module 20 and the low layer module 30, respectively.

Referring to FIGS. 4A-4D, the ring buffer 50 has a storage space between the highest pointer m and the lowest pointer n. Pw represents a pointer where data are written to the ring buffer 50 in case of data transmission. Pr represents a pointer where data are read from the ring buffer 50 in case of data receipt.

In this case, the free buffer size (FBS) can be determined based on the following conditional equation:
if Pr>Pw, FBS=Pr−Pw;
if Pr<Pw, FBS=m−n−Pw+Pr;
if Pr=Pw and TAB=1, FBS=0; or
if Pr=Pw and TAB=0, FBS=m−n. Equation 2

In this Equation 2, the TAB is set to 1 in the instance that the pointer Pw exceeds m. Also, the TAB is set to 0 when the ring buffer 50 becomes empty. In other words, the TAB is set to 0 at the beginning of operation of the ring buffer 50. Then, the TAB is set to 1 in the instant that the pointer Pw exceeds the highest pointer m.

Meanwhile, the TCP/IP stack 40 receives the data size to be written or read to/from the ring buffer 50 from the high layer module 20 and the lower layer module 30. Then, the TCP/IP stack 40 makes a pointer update request for the pointer manager 14 to update the pointers of the ring buffer 50. Generally, in a TCP/IP communication, the TCP/IP stack 40 transforms data transmitted from the high layer module 20 into TCP packets or IP packets so as to output them to networks through the low layer module 30, and extracts the TCP packets from the IP packets received by the low layer module 30 to transmit them to the high layer module 20. Currently, there is a tendency to develop a TCP/IP hardware stack by using hardware in order to complement shortcomings of a sequential processing of TCP/IP software, reduce burdens of a system operating system (OS), and implement parallel data processing.

The high layer module 20 represents a high layer of the TCP/IP stack 40. For example, a socket module of an application layer corresponds to the high layer module. The low layer module 30 represents a low layer of the TCP/IP stack 40. A physical layer such as a network interface card in charge of communication with an external network host corresponds to the low layer module 30.

Now, operation of the ring buffer pointer management system according to an embodiment of the present invention will be described by classifying the cases into data transmission and data receipt.

A. Data Transmission

A-1. Data Write Operation

First, the high layer module 20 transmits a proper data size to be written to the ring buffer 50 to the TCP/IP stack 40 considering the free buffer size transmitted from the layer interface 16. If the TCP/IP stack 40 transmits the data size to be written to the ring buffer 50 to the pointer update interface 12, the pointer update interface 12 calculates a temporary write pointer with reference to a current write pointer transmitted from the pointer manager 14 and a write data size transmitted from the TCP/IP stack 40. The temporary write pointer is calculated based on the above Equation 1.

The TCP/IP stack 40 transmits a temporary pointer update request signal to the pointer manager 14 and writes the data to the ring buffer 50. The pointer manager 14 updates the ring buffer 50 by using the temporary write pointer according to the temporary pointer update request signal from the TCP/IP stack 40, and then calculates the free buffer size of the ring buffer 50 and the occupied buffer size to output the calculated free and occupied buffer sizes to the pointer control block (PCB) 60. The PCB 60 transmits the free buffer size and the occupied buffer size to the layer interface 16, so that the high layer module 20 and the low layer module 30 can use the buffer sizes later.

A-2. Data Read Operation

First, the low layer module 30 transmits a proper data size to be read from the ring buffer 50 to the TCP/IP stack 40 considering the occupied buffer size transmitted from the layer interface 16. If the TCP/IP stack 40 transmits the data size to be read from the ring buffer 50 to the pointer update interface 12, the pointer update interface 12 calculates a temporary read pointer with reference to a current read pointer transmitted from the pointer manager 14 and a read data size transmitted from the TCP/IP stack 40. The temporary read pointer is calculated based on the above Equation 1.

The TCP/IP stack 40 transmits a temporary pointer update request signal to the pointer manager 14. At this point, the TCP/IP stack 40 reads data from the ring buffer 50 and transmits the read data to the low layer module 30. The low layer module 30 transmits the data to an external network host. The pointer manager 14 updates the ring buffer 50 by using the temporary read pointer according to the temporary pointer update request signal from the TCP/IP stack 40, and calculates the free buffer size of the ring buffer 50 and the occupied buffer size to output the calculated free and occupied buffer sizes to the PCB 60. The PCB 60 transmits the free buffer size and the occupied buffer size to the layer interface 16, so that the high layer module 20 and the low layer module 30 can use the buffer sizes later.

B. Data Receipt

B-1 Data Write Operation

First, the low layer module 30 transmits a proper data size to be written to the ring buffer 50 to the TCP/IP stack 40 considering the free buffer size transmitted from the layer interface 16. If the TCP/IP stack 40 transmits the data size to be written to the ring buffer 50 to the pointer update interface 12, the pointer update interface 12 calculates a temporary write pointer with reference to a current write pointer transmitted from the pointer manager 14 and a write data size transmitted from the TCP/IP stack 40. The temporary write pointer is calculated based on the above Equation 1.

The TCP/IP stack 40 transmits a temporary pointer update request signal to the pointer manager 14 and writes the data to the ring buffer 50. The pointer manager 14 updates the ring buffer 50 by using the temporary write pointer according to the temporary pointer update request signal from the TCP/IP stack 40, and calculates the free buffer size of the ring buffer 50 and the occupied buffer size to output the calculated free and occupied buffer sizes to the pointer control block (PCB) 60. The PCB 60 transmits the free buffer size and the occupied buffer size to the layer interface 16, so that the high layer module 20 and the low layer module 30 can use the buffer sizes later.

B-2. Data Read Operation

First, the high layer module 20 transmits a proper data size to be read from the ring buffer 50 to the TCP/IP stack 40 considering an occupied buffer size transmitted from the layer interface 16. If the TCP/IP stack 40 transmits the data size to be read from the ring buffer 50 to the pointer update interface 12, the pointer update interface 12 calculates a temporary read pointer with reference to a current read pointer transmitted from the pointer manager 14 and a read data size transmitted from the TCP/IP stack 40. The temporary read pointer is calculated based on the above Equation 1.

The TCP/IP stack 40 transmits a temporary pointer update request signal to the pointer manager 14. At this point, the TCP/IP stack 40 reads data from the ring buffer 50 and transmits the read data to the high layer module 20. The pointer manager 14 updates the ring buffer 50 by using the temporary read pointer according to the temporary pointer update request signal from the TCP/IP stack 40, and calculates the free buffer size of the ring buffer 50 and the occupied buffer size to output the calculated free and occupied buffer sizes to the PCB 60. The PCB 60 transmits the free buffer size and the occupied buffer size to the layer interface 16, so that the high layer module 20 and the low layer module 30 can use the buffer sizes later.

According to aspects of the present embodiment, the TCP/IP stack 40 and the PCB 60 are excluded from the ring buffer management system. However, in other aspects, they can be included in the ring buffer management system.

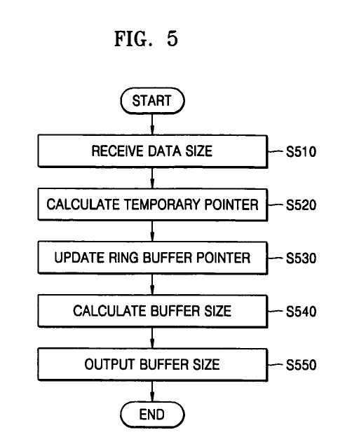

Referring to FIG. 5, in the operation S510, the pointer update interface 12 receives the data size to be written or read to/from the ring buffer 50 from the TCP/IP stack 40. In operation S520, a temporary pointer is calculated based on the data sizes and a current pointer of the ring buffer 50. In addition, in the operation S520, when the sum of the data size and the current pointer exceeds a highest pointer m of the ring buffer 50, a turn-around bit is set to 1 and then additionally output. At this point, the current pointer is calculated by the pointer manager 14 based on the above Equation 1, and then output to the pointer update interface 12. In operation S530, the pointer manager 14 updates the pointer of the ring buffer 50 by using the temporary pointer. In this case, the pointer update is carried out if the temporary pointer update signal is transmitted from the TCP/IP stack 40.

In operation S540, the pointer manager 14 calculates the free buffer size of the ring buffer 50 and the occupied buffer size based on the above Equation 2, and then outputs the calculated free and occupied buffer sizes in operation S550. Therefore, the high layer module 20 and the low layer module 30 can adjust the data size to be written or read to/from the ring buffer 50 based on the buffer sizes output in the operation S550.

According to aspects of the present invention, it is possible to prevent data transmission delay by appropriately adjusting the transmit/receive data size because the highest layer module of the TCP/IP stack which is to write or read data to/from the ring buffer is allowed to immediately identify the free buffer size or the occupied buffer size of the ring buffer.

In addition, it is possible to realize efficient buffer pointer management by deferring update of the buffer pointer before a pointer update signal is received from the TCP/IP stack.

While the present invention has been particularly shown and described with reference to exemplary embodiments thereof, it will be understood by those skilled in the art that various changes in form and details may be made therein without departing from the spirit and scope of the invention as defined by the appended claims and their equivalents. The exemplary embodiments should be considered in descriptive sense only and not for purposes of limitation. Therefore, the scope of the invention is defined not by the detailed description of the invention but by the appended claims and their equivalents, and all differences within the scope will be construed as being included in the present invention.

1. A ring buffer management system implemented by using hardware for TCP/IP communication, the system comprising:
a layer interface which transmits an occupied buffer size and/or a free buffer size of the ring buffer to a low layer module and/or a high layer module of a TCP/IP stack;
a pointer update interface which calculates a temporary pointer based on a current pointer of the ring buffer and a necessary data size for the high layer module and/or the low layer module; and
a pointer manager which stores the current pointer of the ring buffer, updates the ring buffer by using the temporary pointer, and calculates the occupied buffer size and the free buffer size of the ring buffer and transmits the occupied buffer size and the free buffer size to the layer interface.

2. The ring buffer management system according to claim 1, wherein the pointer manager updates the ring buffer by using the temporary pointer when an update request for the temporary pointer is received from the TCP/IP stack.

3. The ring buffer management system according to claim 1, wherein the pointer update interface receives the current pointer from the pointer manager and the necessary data size from the TCP/IP stack to calculate the temporary pointer.

4. The ring buffer management system according to claim 1, wherein the high layer module and the low layer module determine the necessary data size to be smaller than the occupied buffer size and/or the free buffer size transmitted from the layer interface.

5. The ring buffer management system according to claim 1, further comprising:
a pointer control block which stores information on the free buffer size and the occupied buffer size, wherein the pointer manager transmits the free buffer size and the occupied buffer size to the layer interface through the pointer control block.

6. The ring buffer management system according to claim 1, wherein the pointer update interface calculates the temporary pointer based on the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size.

7. The ring buffer management system according to claim 1, wherein the pointer update interface transmits a turn-around bit indicating whether a sum of the current pointer of the ring buffer and the necessary data size exceeds a highest pointer of the ring buffer to the pointer manager, and the pointer manager calculates the free buffer size based on the turn-around bit and the updated temporary pointer.

8. The ring buffer management system according to claim 7, wherein the pointer manager determines the free buffer size based on the following equation:
if Pr>Pw, FBS=Pr−Pw;
if Pr<Pw, FBS=m−n−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer designating a data read point of the ring buffer;
Pw is a temporary write pointer designating a data write point of the ring buffer;
TAB is the turn-around bit; and
FBS is the free buffer size.

9. A ring buffer management system implemented by using hardware for TCP/IP communication, the system comprising:
a TCP/IP hardware stack which implements the TCP/IP communication by using hardware and outputs a pointer update signal for the ring buffer;
a layer interface which transmits an occupied buffer size and/or a free buffer size of the ring buffer to a low layer module and/or a high layer module of the TCP/IP hardware stack;
a pointer update interface which determines a temporary pointer of the ring buffer based on a necessary data size for the high layer module and/or the low layer module and a current pointer of the ring buffer, and outputs a turn-around bit indicating whether a sum of the current pointer and the necessary data size exceeds a highest pointer of the ring buffer together with the temporary pointer;
a pointer manager which transmits the current pointer of the ring buffer to the pointer update interface, receives the pointer update signal output from the TCP/IP hardware stack, updates the ring buffer by using the temporary pointer in response to the pointer update signal, and calculates and outputs the free buffer size and/or the occupied buffer size based on the turn-around bit output from the pointer update interface and the temporary pointer; and
a pointer control block which stores the occupied buffer size and/or the free buffer size output from the pointer manager and transmits the stored occupied buffer size and/or the free buffer size to the layer interface.

10. The system according to claim 9, wherein the pointer update interface determines the temporary pointer based on the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size.

11. The system according to claim 9, wherein the pointer manager determines the free buffer size based on the following equation:
if Pr>Pw, FBS=Pr−Pw;
if Pr<Pw, FBS=m−m−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer designating a data read point of the ring buffer;
Pw is a temporary write pointer designating a data write point of the ring buffer;
TAB is the turn-around bit; and
FBS is the free buffer size.

12. A ring buffer management method implemented by using hardware for TCP/IP communication, the method comprising:
receiving a necessary data size from a TCP/IP stack;
calculating a temporary pointer based on the necessary data size and a current pointer of the ring buffer;
updating the ring buffer by using the temporary pointer;
calculating an occupied buffer size and a free buffer size of the ring buffer; and
transmitting the calculated free buffer size and/or the occupied buffer size to a low layer module and/or a high layer module of the TCP/IP stack.

13. The ring buffer management method according to claim 12, wherein the updating the ring buffer comprises using the temporary pointer when an update request for the temporary pointer is received from the TCP/IP stack.

14. The ring buffer management method according to claim 12, further comprising:
adjusting the necessary data size to be smaller than the calculated occupied buffer size and the free buffer size; and
transmitting the adjusted necessary data size to the TCP/IP stack.

15. The ring buffer management method according to claim 12, wherein the calculating the temporary pointer is calculated by the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size.

16. The ring buffer management method according to claim 12, further comprising:
generating a turn-around bit indicating whether a sum of the necessary data size and a current write pointer of the ring buffer exceeds a highest pointer of the ring buffer, wherein the calculating the occupied buffer size and the free buffer size comprises calculating the free buffer size based on the generated turn-around bit and the temporary pointer.

17. The ring buffer management method according to claim 16, wherein the free buffer size is determined based on the following equation:
if Pr>Pw, FBS=Pr−Pw;
if Pr<Pw, FBS=m−m−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer designating a data read point of the ring buffer;
Pw is a temporary write pointer designating a data write point of the ring buffer;
TAB is the turn-around bit; and
FBS is the free buffer size.

18. A ring buffer management method implemented by using hardware for TCP/IP communication, the method comprising:
receiving a necessary data size from a TCP/IP stack;
calculating a temporary pointer based on the necessary data size and a current pointer of the ring buffer;
generating a turn-around bit indicating whether a sum of the current pointer of the buffer and the necessary data size exceeds a highest pointer of the ring buffer;
updating the ring buffer by using the temporary pointer when a pointer update signal is received from the TCP/IP stack;
calculating an occupied buffer size and a free buffer size of the ring buffer based on the temporary pointer and the turn-around bit; and
transmitting the calculated free buffer size and/or the occupied buffer size to a high layer module and/or a low layer module of the TCP/IP stack.

19. The ring buffer management method according to claim 18, wherein the temporary pointer is determined based on the following equation:
if (Pp+Ds)≦m, Pn=Pp+Ds; or
if (Pp+Ds)>m, Pn=Pp+Ds+n−m,
where, m is a highest pointer of the ring buffer;
n is a lowest pointer of the ring buffer;
Pp is the current pointer;
Pn is the temporary pointer; and
Ds is the necessary data size.

20. The ring buffer management method according to claim 18, wherein the free buffer size is determined based on the following equation:
if Pr>Pw, FBS=Pr−Pw;
if Pr<Pw, FBS=m−m−Pw+Pr;
if Pr=Pw and TAB=1, FBS=0; or
if Pr=Pw and TAB=0, FBS=m−n,
where, m is a highest pointer of the ring buffer;
n is a lowest pointer of the ring buffer;
Pr is an updated temporary read pointer designating a data read point of the ring buffer;
Pw is a temporary write pointer designating a data write point of the ring buffer;
TAB is the turn-around bit; and
FBS is the free buffer size.

21. A ring buffer management method, comprising:
receiving an initial data size of data to be written to or read from the ring buffer;
calculating one of a temporary read pointer or a temporary write pointer according to the initial data size and a corresponding current read pointer or current write pointer of the ring buffer according to whether the data is to be read from or written to the ring buffer;
comparing the one of the temporary read pointer or the temporary write pointer to a maximum pointer of the ring buffer;
setting the one of the temporary read pointer or the temporary write pointer if the one of the temporary read pointer or the temporary write pointer is less than or equal to the maximum pointer as the corresponding current read pointer or current write pointer;
setting the one of the temporary read pointer or the temporary write pointer according to the initial data size and a corresponding current read pointer or a current write pointer of the ring buffer and difference between a minimum pointer of the ring buffer and the maximum pointer of the ring buffer if the one of the temporary read pointer or the temporary write pointer is greater than the maximum pointer as the corresponding current read pointer or current write pointer;
updating the ring buffer according to the corresponding current read pointer or current write pointer;
generating an occupied buffer size and a free buffer size of the ring buffer based on the corresponding current read pointer or current write pointer; and
determining the initial data size of the data to be written to or read from the ring buffer according to the generated occupied buffer size and free buffer size of the ring buffer.

22. A ring buffer management method, comprising:
determining a free buffer size and an occupied buffer size of the ring buffer; and
adjusting a read or write size of data communicating with the ring buffer based on the determination of the free buffer size and the occupied buffer size of the ring buffer.

23. The ring buffer management method of claim 22, wherein the determining on the real-time basis the free buffer size and the occupied buffer size comprises:
receiving an initial read or write size of the data from a TCP/IP stack;
calculating a temporary pointer based on the initial data size and a current pointer of the ring buffer;
updating the ring buffer according to the temporary pointer when an update signal is received from the TCP/IP stack;
calculating the free buffer size and the occupied buffer size of the ring buffer based on the updated ring buffer and the temporary pointer; and
transmitting the calculated free buffer size and the occupied buffer size to the TCP/IP stack.

24. The ring buffer management method of claim 22, wherein the determining the free buffer size and the occupied buffer size of the ring buffer is on a real-time basis.

25. A method of managing a write process and a read process of a ring buffer, the ring buffer having a minimum address pointer, a maximum address pointer, the write process using a read pointer designating a location of an address of data being read from the ring buffer during the read operation,
the write process comprising:
receiving an initial write size of the data from a TCP/IP stack;
calculating a temporary write pointer based on the initial data size and a current write pointer designating a location of the address of the data being written to the ring buffer;
updating the current write pointer of the ring buffer according to the temporary write pointer when an update signal is received from the TCP/IP stack;
calculating a free buffer size and an occupied buffer size of the ring buffer based on the updated ring buffer and the temporary write pointer;
transmitting the calculated free buffer size and occupied buffer size to the TCP/IP stack; and
the read process comprising:
receiving an initial read size of the data from a TCP/IP stack;
calculating a temporary read pointer based on the initial data size and a current read pointer designating a location of an address of data being read from the ring buffer;
updating the current read pointer of the ring buffer according to the temporary read pointer when an update signal is received from the TCP/IP stack;
calculating the free buffer size and the occupied buffer size of the ring buffer based on the updated ring buffer and the temporary read pointer; and
transmitting the calculated free buffer size and the occupied buffer size to the TCP/IP stack,
wherein the updating the current write pointer of the ring buffer is deferred if the calculated temporary write pointer exceeds the current read pointer, and the updating of the current read pointer of the ring buffer is deferred if the calculated temporary read pointer exceeds the current write pointer.
